(19) United States
(12) Patent Application Publication
(10) Pub. No.: US 2026/0154818 A1
(43) Pub. Date: Jun. 4, 2026

(54) OCT IMAGE QUALITY

(71) Applicant: Carl Zeiss Meditec, Inc., Dublin, CA (US)

(72) Inventor: Homayoun Bagherinia, Oakland, CA (US)

(73) Assignee: Carl Zeiss Meditec, Inc., Dublin, CA (US)

(21) Appl. No.: 19/407,722

(22) Filed: Dec. 3, 2025

Related U.S. Application Data
(60) Provisional application No. 63/727,820, filed on Dec. 4, 2024.

(51) Int. Cl. G06T 7/00; G06T 7/60; G06T 7/73

(52) U.S. Cl. CPC G06T 7/0012; G06T 7/60; G06T 7/74; G06T 2207/10101; G06T 2207/20076; G06T 2207/30041; G06T 2207/30168

(57) ABSTRACT

A system, method and device are disclosed for determining a quality index of Optical Coherence Tomography data. The method of determining a quality index (or matric) of Optical Coherence Tomography data may comprise using a distance probability function to determine a quality index, wherein the quality index is calculated from an OCT quality map, wherein the best OCT quality maps are modeled as a subspace and wherein the distance of an OCT quality map to the subspace is a measure of the OCT quality.

### CROSS-REFERENCE TO RELATED APPLICATIONS

This application claims priority to, and the benefit of, Provisional Patent Application No. 63/727,820, filed Dec. 4, 2024, and titled “OCT IMAGE QUALITY,” which is incorporated by reference herein in its entirety for all purposes.

### FIELD

The present disclosure is generally directed to determining a metric for quantifying quality of Optical Coherence Tomography (OCT) data. More specifically, the disclosure is directed to determining an OCT data quality metric or OCT image quality metric based on a sub-space.

### BACKGROUND

Optical coherence tomography (OCT) is a non-invasive imaging technique that uses light waves to penetrate tissue and produce image information at different depths within the tissue, such as an eye. Generally, an OCT system is an interferometric imaging system based on detecting the interference of a reference beam and backscattered light from a sample illuminated by an OCT beam. Each scattering profile in the depth direction (e.g., z-axis or axial direction) may be reconstructed individually into an axial scan, or A-scan. Cross-sectional slice images (e.g., two-dimensional (2D) bifurcating scans, or B-scans) and volume images (e.g., 3D cube scans, or C-scans or volume scans) may be built up from multiple A-scans acquired as the OCT beam is scanned/moved through a set of transverse (e.g., x-axis and/or y-axis) locations on the sample. When applied to the retina of an eye, OCT generally provides structural data that, for example, permits one to view, at least in part, distinctive tissue layers and vascular structures of the retina. OCT angiography (OCTA) expands the functionality of an OCT system to also identify (e.g., render in image format) the presence, or lack, of blood flow in retinal tissue. For example, OCTA may identify blood flow by identifying differences over time (e.g., contrast differences) in multiple OCT scans of the same retinal region, and designating differences in the scans that meet predefined criteria as blood flow.

An OCT system also permits construction of a planar (2D), frontal view (e.g., en face) image of a select portion of a tissue volume (e.g., a target tissue slab (sub-volume) or target tissue layer(s), such as the retina of an eye). Examples of other 2D representations (e.g., 2D maps) of ophthalmic data provided by an OCT system may include layer thickness maps and retinal curvature maps. For example, to generate layer thickness maps, an OCT system may combine en face images, 2D vasculature maps of the retina, with multilayer segmentation data. Thickness maps may be based, at least in part, on measured thickness difference between retinal layer boundaries. Vasculature maps and OCT en face images may be generated, for example, by projecting onto a 2D surface a sub-volume (e.g., tissue slab) defined between two selected layer-boundaries. The projection may use the sub-volume's mean, sum, percentile, or other data aggregation method between the selected two layer-boundaries. Thus, the creation of these 2D representations of a 3D volume (or sub-volume) data often relies on the effectiveness of automated (multi) retinal layer segmentation algorithm(s) to identify the retinal layers (or layer-boundaries) upon which the 2D representations are based/defined.

The ability of OCT to provide the above capabilities is predicated on the quality of captured (obtained/scanned/detected) OCT data/image. OCT image quality is a common problem, which could potentially lead to incorrect clinical interpretation. OCT image quality can be affected by the signal strength (SS), signal to noise ratio (SNR), contrast, retinal position in the scan, stripe banding and shadowing (caused by position of the retina in SD-OCT or partial blink), vignetting, and other minor artifacts.

OCT devices provide an image quality index that is used as the threshold for acceptable image criteria. The quality index has typically been calculated using (e.g., determined based on) signal processing measures such as signal strength (SS) or signal to noise ratio (SNR). However, such a quality index captures only a few aspects of the OCT data quality and does not represent the overall quality of an OCT volume data. This can lead to unreliable measurements.

The systems and methods may provide a new quality index of OCT data/image quality that is more accurate than the above-described approach.

The systems and methods may provide a quality index based on (e.g., calculated from) an OCT quality map.

The systems and methods may define a subspace based on the best OCT quality maps for use in determining a quality index.

The systems and methods may define a quality index based on a distance probability function.

### SUMMARY

The present systems and methods may determine an OCT quality measure (metric) using a sub-space based on quality maps and a distance probability function.

The quality index of OCT data has heretofore been determined/calculated using signal processing measures, such as signal strength (SS) or signal to noise ratio (SNR). In the present approach, a quality index of OCT data is calculated from one or more OCT quality map. Multiple OCT quality maps are obtained, and the best OCT quality maps are modeled as a subspace. A distance of an OCT quality map to the subspace is defined as a measure of OCT quality, and the quality index is determined from a distance probability function.

Several publications may be cited or referred to herein to facilitate the understanding of the present disclosure. All publications cited or referred to herein, are hereby incorporated herein in their entirety by reference for all purposes.

The various embodiments disclosed herein are only examples, and the scope of this disclosure is not limited to them. Any embodiment feature mentioned in one claim category, e.g. system, can be claimed in another claim category, e.g. method, as well. The dependencies or references back in the attached claims are chosen for formal reasons only. However, any subject matter resulting from a deliberate reference back to any previous claims can be claimed as well, so that any combination of claims and the features thereof are disclosed and can be claimed regardless of the dependencies chosen in the attached claims.

### BRIEF DESCRIPTION OF THE DRAWINGS

In the drawings wherein like reference symbols/characters refer to like parts:

FIG. 1 provides an overview of an exemplary method for defining (determining or calculating) an OCT quality index, in accordance with the various embodiments.

FIG. 2 shows exemplary steps for determining (calculating) the quality index 17 of FIG. 1, in accordance with the various embodiments.

FIG. 3 is a plot of singular values of an exemplary SVD of a matrix M versus the number of dimensions of a feature vector (144 dimensions), and showing that 95% of the variance is explained by the first 20 dimensions, in accordance with the various embodiments.

FIG. 4 is an exemplary curve (e^{αd}, α=−120) (fitted to a plot of normalized square distances d (calculated from several OCT quality maps with varying quality)) that represents the probability function, in accordance with the various embodiments.

FIGS. 5, 6, and 7 are three examples of determining a quality index, as compared to determining an average quality measure from a quality map, in accordance with the various embodiments.

FIG. 8 illustrates a generalized frequency domain optical coherence tomography system used to collect 3D image data of the eye, in accordance with the various embodiments.

FIG. 9 shows an exemplary OCT B-scan image of a normal retina of a human eye, and illustratively identifies various canonical retinal layers and boundaries, in accordance with the various embodiments.

FIG. 10 shows an example of an en face vasculature image, in accordance with the various embodiments.

FIG. 11 shows an exemplary B-scan of a vasculature (OCTA) image, in accordance with the various embodiments.

FIG. 12 illustrates an example computer system (or computing device or computer), in accordance with the various embodiments.

### DETAILED DESCRIPTION

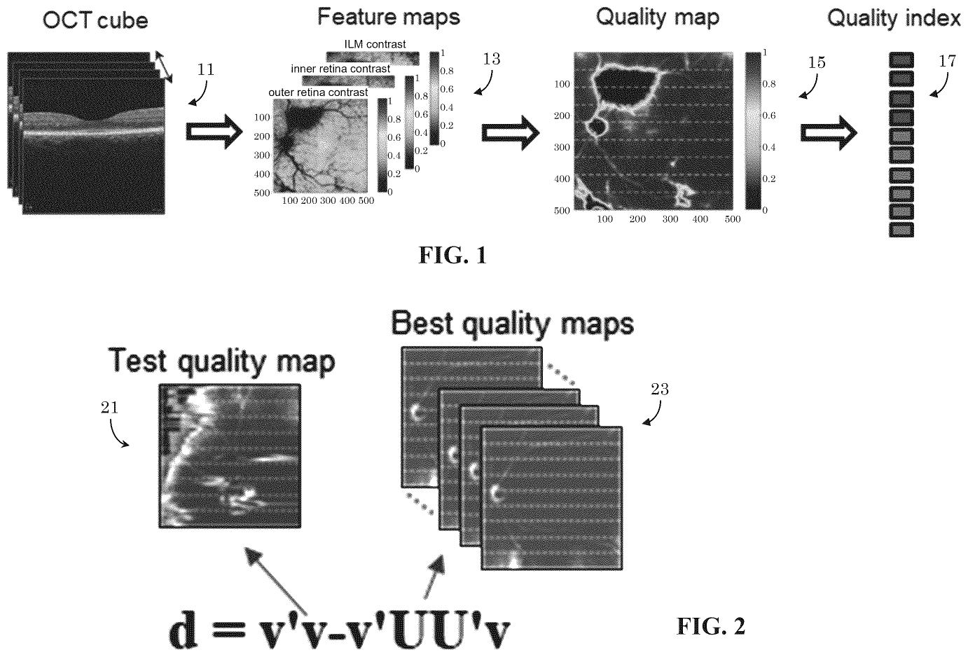

The following steps show details of the functionality behind the present method of determining an OCT signal quality index. FIG. 1 provides an overview of a method for defining (determining or calculating) an OCT quality index, in accordance with the various embodiments. This overview is divided into multiple steps for determining the quality index.

### Feature Maps

With reference to FIG. 1, first an OCT volume (or OCT cube scan) 11 (or other type of appropriate OCT scan, such as a B-scan) is acquired. As is explained more fully below, an OCT cube scan consisting of multiple B-scans (two dimensional scans comprised of multiple adjacent A-scans). Multiple feature maps 13 are then defined from the OCT cube 11 (e.g., multiple feature maps per B-scan of OCT cube 11). In present implementation, the feature maps may be defined from determined quality of each A-scan, but other types of feature maps are envisioned, in accordance with the various embodiments. The quality of an A-scan or group of neighboring A-scans can be determined/defined/measured from (by use of) a set of select metrics. For example, a set of metrics (e.g., three metrics, such as signal strength (mean intensity), signal to background ratio (SBR), and signal contrast) and signal (e.g., A-scan) position within a given B-scan can be used to create multiple feature maps 13. In the present example, four feature maps 13 (e.g., an ILM contrast feature map, an inner retina contrast feature map, and outer retinal contrast feature map) are defined for all A-scans in the OCT volume 11. The pixel dimensions of a feature map are the same as the lateral pixel dimensions of the OCT volume 11. For instance, the three metrics can be used during alignment by calculating a quality score using one or more B-scans.

Note that other metrics such as entropy or higher statistical moments could be used to create additional feature maps. However, any additional metrics could be redundant or create more computational complexity which may not be desirable.

### Quality Map

A group of feature maps are then combined into a single quality map 15. Multiple groups may define multiple quality maps. The quality map 15 indicates the local quality of an OCT scan. Using this map helps an operator (e.g., user of an OCT system) or an automated algorithm to determine if an OCT scan qualifies for further analysis. Other applications would be to exclude scan areas with poor quality from any type of quantification. Quality map can be created using Bayesian inference or Batesian inference as shown in the following figure. For Bayesian inference, likelihood functions for good and poor feature map data may be used. Likelihood functions are determined by grouping the feature map data as poor and good quality.

### Quality Index

The overall quality of the OCT cube 11 can be summarized as a quality index 17. The quality index can be calculated using the feature maps 13 directly or using the quality map 15.

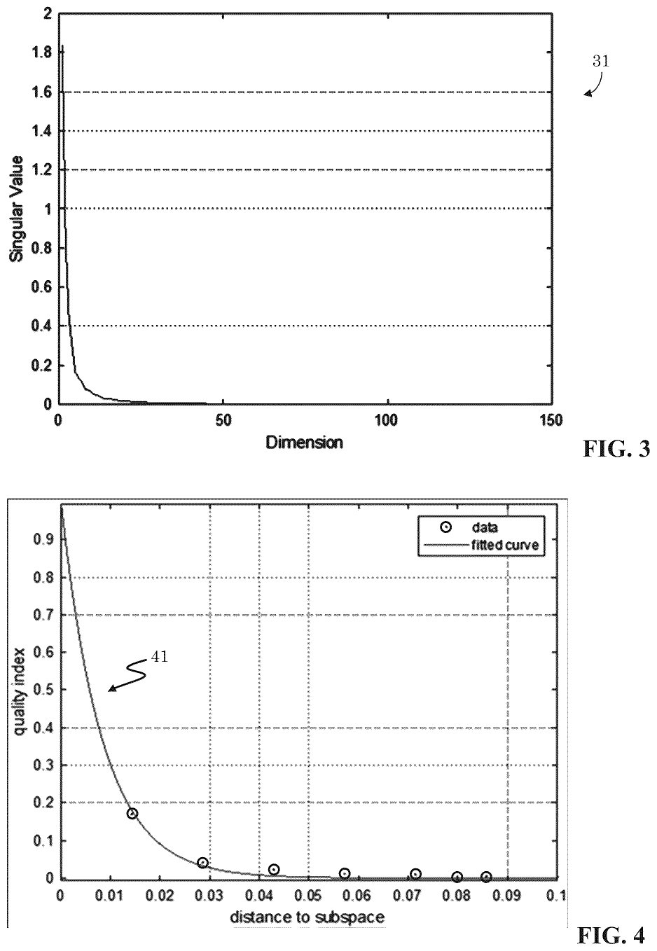

FIG. 2 shows steps for determining (calculating) the quality index 17 of FIG. 1. In FIG. 2, d represents the square distance of a feature vector v of a quality map (e.g., “Test quality map”) to a subspace U defined from the best quality maps 23. Subspace U is calculated based on the best quality maps 23 represented as feature vectors. A feature vector is determined from average valued (e.g., the averaging) of n-patches of a quality map. Alternatively, a feature vector can be determined from average valued of n-patches of the feature maps directly. A singular value decomposition (SVD) of a matrix M, whose columns consists of the best quality maps feature vectors, is calculated as

[U1 S1 V1]=SVD(M)
where S1 is a diagonal matrix whose values are sorted from largest to smallest value. Then, U represents the first n-columns of U1 associated with a specified amount of variance (e.g. 95%) explained by first n-singular values. For instance, with reference to FIG. 3, the plot of the singular values (of a feature vector of 144 dimensions) shows that the dimension of U is n=20 (first 20 out of 144 dimensions) which explains 95% of the variance.

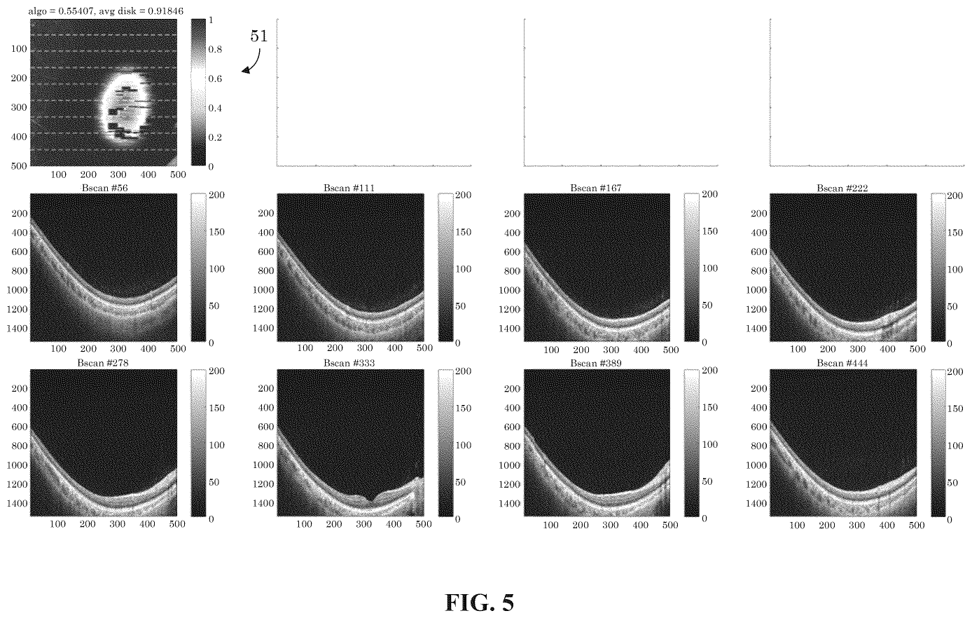

The quality index 17 is determined from the probability function of the square distances d which are calculated from several OCT quality maps with varying quality. The probability function of the square distances is determined from a square distances histogram. With reference to FIG. 4, fitted curve 41 is an exponential fit (e^{αd}, α=−120) to the normalized histogram of square distances represents the probability function.

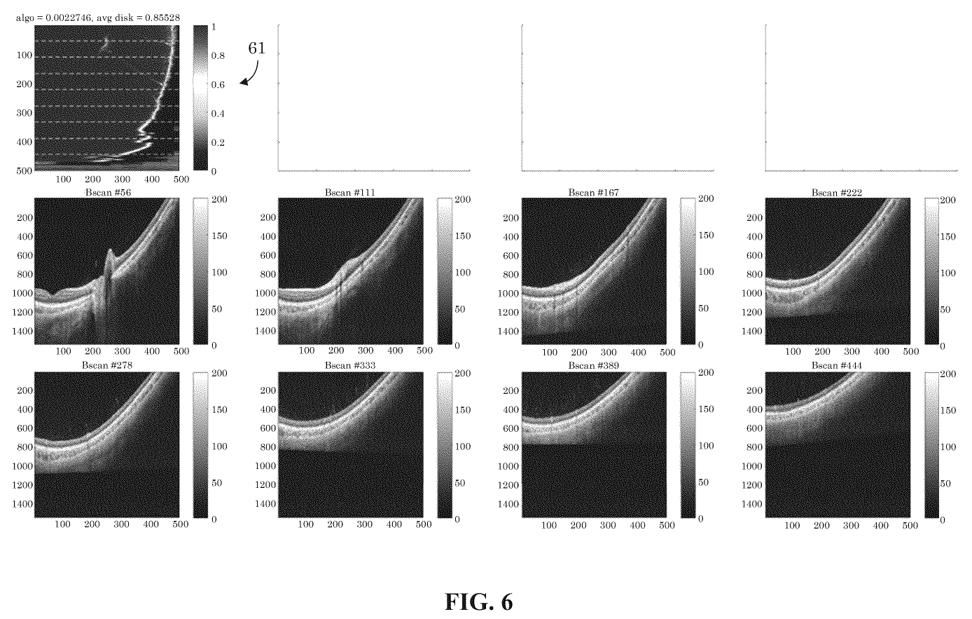

With reference to FIG. 5, the quality index for the present example was calculated as 0.55 (algo=0.55407), as described above. When compared to the average quality of 0.92 (avg disk=0.91846) determined from the quality map 51, the presently calculated quality index represents a more accurate number due to a significant portion of the retina being out of the OCT B-scan, as seen in the provided Bscan samples of the C-scan (not shown).

The quality index for the example of FIG. 6 was calculated as 0.002 (algo=0.0022746), as compared to an average quality of 0.86 (avg disk=0.85528) calculated from the quality map 61. The present quality index represents a more accurate number due to a significant portion of the retina being out of the OCT B-scan despite a good signal strength and SNR.

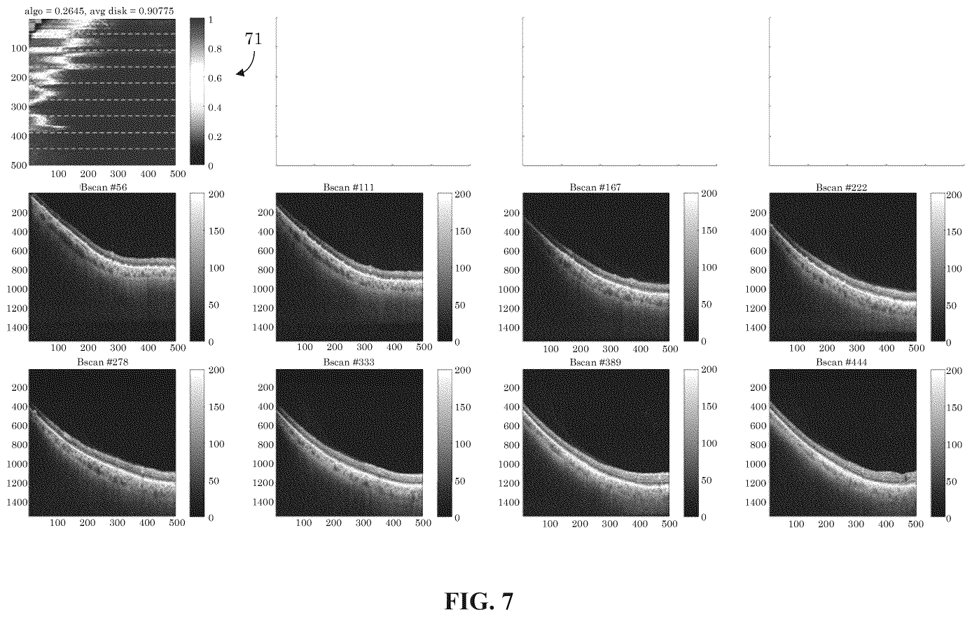

The quality index for the example of FIG. 7 was calculated as 0.26 (algo=0.2645), as compared to an average quality of 0.91 (avg disk=0.90775) calculated from the quality map 71. The quality index represents a more accurate number due to a significant portion of the retina having low quality (upper left).

### Optical Coherence Tomography Imaging System

Generally, optical coherence tomography (OCT) uses low-coherence light to produce two-dimensional (2D) and three-dimensional (3D) internal views of biological tissue. OCT enables in vivo imaging of retinal structures. OCT angiography (OCTA) produces flow information, such as vascular flow from within the retina. Examples of OCT systems are provided in U.S. Pat. Nos. 6,741,359 and 9,706,915, and examples of an OCTA systems may be found in U.S. Pat. Nos. 9,700,206 and 9,759,544, all of which are herein incorporated in their entirety by reference. An exemplary OCT/OCTA system is provided herein.

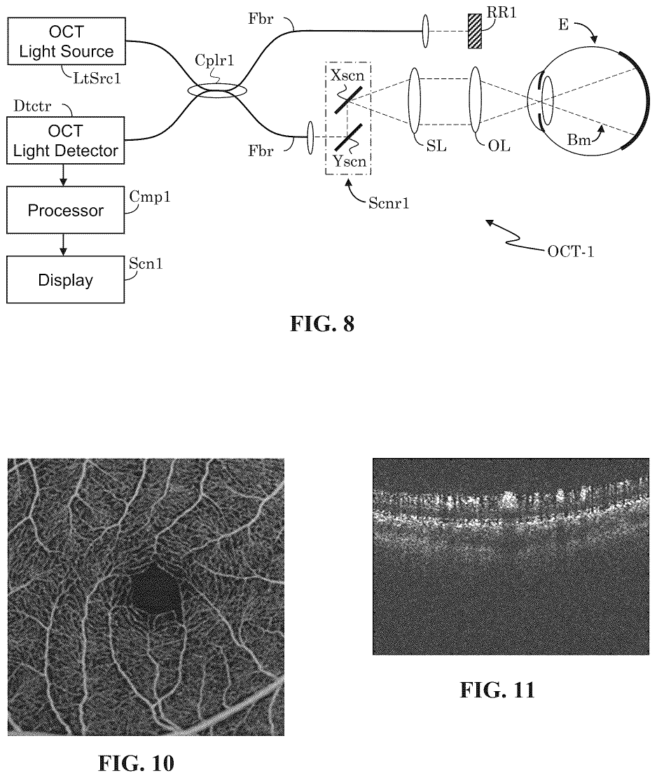

FIG. 8 illustrates a generalized frequency domain optical coherence tomography (FD-OCT) system used to collect 3D image data of the eye, in accordance with the various embodiments. An FD-OCT system OCT_1 includes a light source, LtSrc1. Typical light sources include, but are not limited to, broadband light sources with short temporal coherence lengths or swept laser sources. A beam of light from light source LtSrc1 is routed, typically by optical fiber Fbr1, to illuminate a sample, e.g., eye E; a typical sample being tissues in the human eye. The light source LrSrc1 may, for example, be a broadband light source with short temporal coherence length in the case of spectral domain OCT (SD-OCT) or a wavelength tunable laser source in the case of swept source OCT (SS-OCT). The light may be scanned, typically with a scanner Scnr1 between the output of the optical fiber Fbr1 and the sample E, so that the beam of light (dashed line Bm) is scanned laterally over the region of the sample to be imaged. The light beam from scanner Scnr1 may pass through a scan lens SL and an ophthalmic lens OL and be focused onto the sample E being imaged. The scan lens SL (or telecentric scan lens) is used to scan a light beam across the sample. The scan lens helps ensure the light beam's focal point (or focal line) moves linearly and consistently across a flat imaging plane. Together with the ophthalmic lens OL, the light beam is focused onto the sample. The present example illustrates a scan beam that is scanned in two lateral directions (e.g., in x and y directions on a Cartesian plane) to scan a desired field of view (FOV). An example of this would be a point-field OCT, which uses a point-field beam to scan across a sample. Consequently, scanner Scnr1 is illustratively shown to include two sub-scanner: a first sub-scanner Xscn for scanning the point-field beam across the sample in a first direction (e.g., a horizontal x-direction); and a second sub-scanner Yscn for scanning the point-field beam on the sample in traversing second direction (e.g., a vertical y-direction). If the scan beam were a line-field beam (e.g., a line-field OCT), which may sample an entire line-portion of the sample at a time, then only one scanner is used to scan the line-field beam across the sample to span the desired FOV. If the scan beam were a full-field beam (e.g., a full-field OCT), no scanner may be needed, and the full-field light beam may be applied across the entire, desired FOV at once.

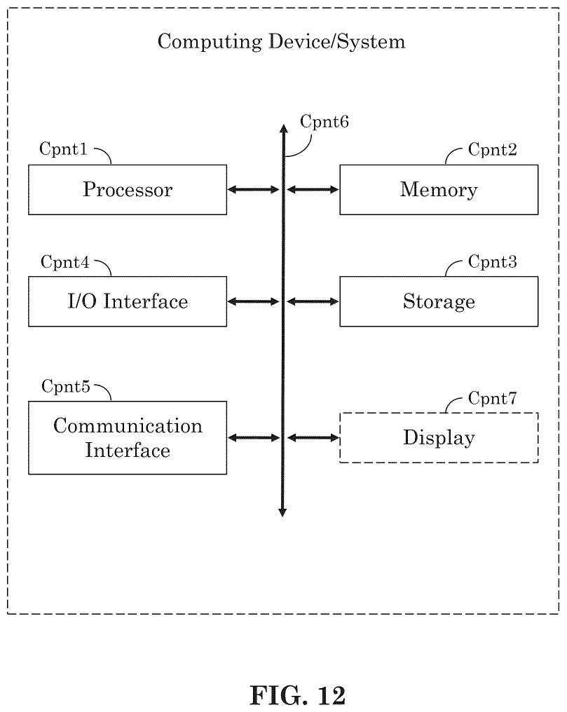

Irrespective of the type of beam used, light scattered from the sample (e.g., sample light) is collected. In the present example, scattered light returning from the sample is collected into the same optical fiber Fbr1 used to route the light for illumination. Reference light derived from the same light source LtSrc1 travels a separate path, in this case involving optical fiber Fbr2 and retro-reflector RRI with an adjustable optical delay. Those skilled in the art will recognize that a transmissive reference path can also be used and that the adjustable delay could be placed in the sample or reference arm of the interferometer. Collected sample light is combined with reference light, for example, in a fiber coupler Cplr1, to form light interference in an OCT light detector Dtctr1 (e.g., photodetector array, digital camera, etc.). Although a single fiber port is shown going to the detector Dtctr1, those skilled in the art will recognize that various designs of interferometers can be used for balanced or unbalanced detection of the interference signal. The output from the detector Dtctr1 is supplied to a processor (e.g., internal or external computing device) Cmp1 that converts the observed interference into depth information of the sample. The depth information may be stored in a memory associated with the processor Cmp1 and/or displayed on a display (e.g., computer/electronic display/screen) Scn1. The processing and storing functions may be localized within the OCT instrument, or functions may be offloaded onto (e.g., performed on) an external processor (e.g., an external computing device), to which the collected data may be transferred. An example of a computing device (or computer system) is shown in FIG. 12. This unit could be dedicated to data processing or perform other tasks which are quite general and not dedicated to the OCT device. The processor (computing device) Cmp1 may include, for example, a field-programmable gate array (FPGA), a digital signal processor (DSP), an application specific integrated circuit (ASIC), a graphics processing unit (GPU), a system on chip (SoC), a central processing unit (CPU), a general purpose graphics processing unit (GPGPU), or a combination thereof, that may performs some, or the entire, processing steps in a serial and/or parallelized fashion with one or more host processors and/or one or more external computing devices.

The sample and reference arms in the interferometer could consist of bulk-optics, fiber-optics, or hybrid bulk-optic systems and could have different architectures such as Michelson, Mach-Zehnder or common-path based designs as would be known by those skilled in the art. Light beam as used herein should be interpreted as any carefully directed light path. Instead of mechanically scanning the beam, a field of light can illuminate a one or two-dimensional area of the retina to generate the OCT data (see for example, U.S. Pat. No. 9,332,902; D. Hillmann et al, “Holoscopy—Holographic Optical Coherence Tomography,” Optics Letters, 36 (13): 2390 2011; Y. Nakamura, et al, “High-Speed Three Dimensional Human Retinal Imaging by Line Field Spectral Domain Optical Coherence Tomography,” Optics Express, 15 (12):7103 2007; Blazkiewicz et al, “Signal-To-Noise Ratio Study of Full-Field Fourier-Domain Optical Coherence Tomography,” Applied Optics, 44(36): 7722 (2005)). In time-domain systems, the reference arm has a tunable optical delay to generate interference. Balanced detection systems are typically used in TD-OCT and SS-OCT systems, while spectrometers are used at the detection port for SD-OCT systems. The disclosed method could be applied to any type of OCT system. Various aspects of the methods could apply to any type of OCT system or other types of ophthalmic diagnostic systems and/or multiple ophthalmic diagnostic systems including but not limited to fundus imaging systems, visual field test devices, and scanning laser polarimeters.

In Fourier Domain optical coherence tomography (FD-OCT), each measurement is the real-valued spectral interferogram (Sj(k)). The real-valued spectral data typically goes through several post-processing steps including background subtraction, dispersion correction, etc. The Fourier transform of the processed interferogram, results in a complex valued OCT signal output Aj(z)=|Aj|eiφ. The absolute value of this complex OCT signal, |Aj|, reveals the profile of scattering intensities at different path lengths, and therefore scattering as a function of depth (z-direction) in the sample. Similarly, the phase, φj can also be extracted from the complex valued OCT signal. The profile of scattering as a function of depth is called an axial scan (A-scan). A set of A-scans measured at neighboring locations in the sample produces a cross-sectional image (tomogram or B-scan) of the sample. A collection of B-scans collected at different transverse locations on the sample makes up a data volume or cube. For a particular volume of data, the term fast axis refers to the scan direction along a single B-scan whereas slow axis refers to the axis along which multiple B-scans are collected. The term “cluster scan” may refer to a single unit or block of data generated by repeated acquisitions at the same (or substantially the same) location (or region) for the purposes of analyzing motion contrast, which may be used to identify blood flow. A cluster scan can consist of multiple A-scans or B-scans collected with relatively short time separations at approximately the same location(s) on the sample. Since the scans in a cluster scan are of the same region, static structures remain relatively unchanged from scan to scan within the cluster scan, whereas motion contrast between the scans that meets predefined criteria may be identified as blood flow.

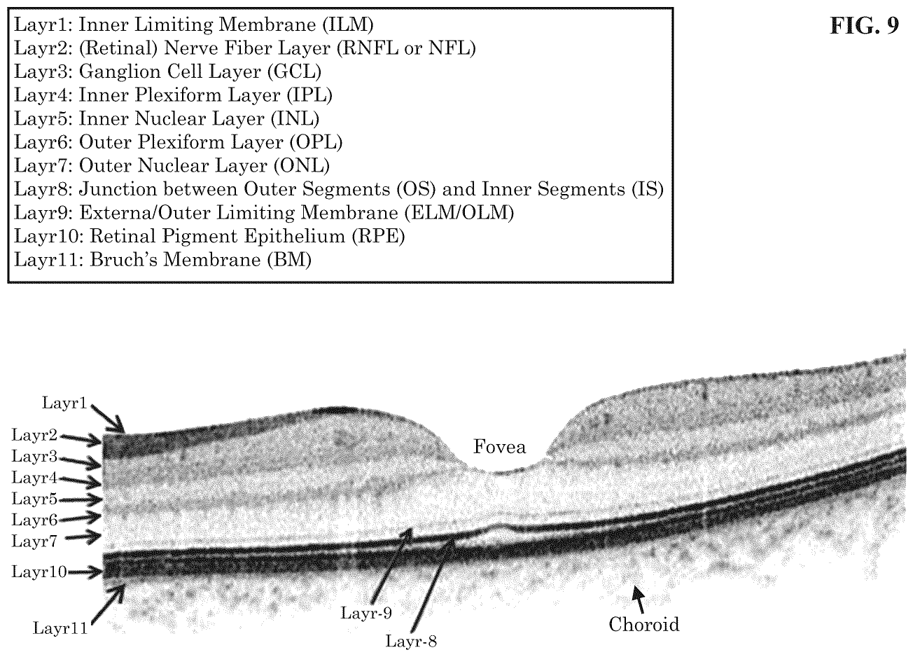

A variety of ways to create B-scans are known in the art including but not limited to: along the horizontal or x-direction, along the vertical or y-direction, along the diagonal of x and y, or in a circular or spiral pattern. B-scans may be in the x-z dimensions but may be any cross-sectional image that includes the z-dimension. An example OCT B-scan image of a normal retina of a human eye is illustrated in FIG. 9. An OCT B-scan of the retinal provides a view of the structure of retinal tissue. For illustration purposes, FIG. 9 identifies various canonical retinal layers and layer boundaries. The identified retinal boundary layers include (from top to bottom): the inner limiting membrane (ILM) Lyer1, the retinal nerve fiber layer (RNFL or NFL) Layr2, the ganglion cell layer (GCL) Layr3, the inner plexiform layer (IPL) Layr4, the inner nuclear layer (INL) Layr5, the outer plexiform layer (OPL) Layr6, the outer nuclear layer (ONL) Layr7, the junction between the outer segments (OS) and inner segments (IS) (indicated by reference character Layr8) of the photoreceptors, the external or outer limiting membrane (ELM or OLM) Layr9, the retinal pigment epithelium (RPE) Layr10, and the Bruch's membrane (BM) Layr11.

In OCT Angiography, or Functional OCT, analysis algorithms may be applied to OCT data collected at the same, or approximately the same, sample locations on a sample at different times (e.g., a cluster scan) to analyze motion or flow (see for example US Patent Publication Nos. 2005/0171438, 2012/0307014, 2010/0027857, 2012/0277579 and U.S. Pat. No. 6,549,801, all of which are herein incorporated in their entirety by reference). An OCT system may use any one of a number of OCT angiography processing algorithms (e.g., motion contrast algorithms) to identify blood flow. For example, motion contrast algorithms can be applied to the intensity information derived from the image data (intensity-based algorithm), the phase information from the image data (phase-based algorithm), or the complex image data (complex-based algorithm). An en face image is a 2D projection of 3D OCT data (e.g., by averaging the intensity of each individual A-scan, such that each A-scan defines a pixel in the 2D projection). Similarly, an en face vasculature image is an image displaying motion contrast signal in which the data dimension corresponding to depth (e.g., z-direction along an A-scan) is displayed as a single representative value (e.g., a pixel in a 2D projection image), typically by summing or integrating all or an isolated portion of the data (see for example U.S. Pat. No. 7,301,644 herein incorporated in its entirety by reference). OCT systems that provide an angiography imaging functionality may be termed OCT angiography (OCTA) systems.

FIG. 10 shows an example of an en face vasculature image. After processing the data to highlight motion contrast using any of the motion contrast techniques known in the art, a range of pixels corresponding to a given tissue depth from the surface of internal limiting membrane (ILM) in retina, may be summed to generate the en face (e.g., frontal view) image of the vasculature. FIG. 11 shows an exemplary B-scan of a vasculature (OCTA) image. As illustrated, structural information may not be well-defined since blood flow may traverse multiple retinal layers making them less defined than in a structural OCT B-scan, as shown in FIG. 9. Nonetheless, OCTA provides a non-invasive technique for imaging the microvasculature of the retina and the choroid, which may be critical to diagnosing and/or monitoring various pathologies. For example, OCTA may be used to identify diabetic retinopathy by identifying microaneurysms, neovascular complexes, and quantifying foveal avascular zone and nonperfused areas. Moreover, OCTA has been shown to be in good agreement with fluorescein angiography (FA), a more traditional, but more evasive, technique including the injection of a dye to observe vascular flow in the retina. Additionally, in dry age-related macular degeneration, OCTA has been used to monitor a general decrease in choriocapillaris flow. Similarly in wet age-related macular degeneration, OCTA can provides a qualitative and quantitative analysis of choroidal neovascular membranes. OCTA has also been used to study vascular occlusions, e.g., evaluation of nonperfused areas and the integrity of superficial and deep plexus.

### Computing Device/System

FIG. 12 illustrates an exemplary computer system (or computing device or computer device). In some embodiments, one or more computer systems may provide the functionality described or illustrated herein and/or perform one or more steps of one or more methods described or illustrated herein. The computer system may take any suitable physical form. For example, the computer system may be an embedded computer system, a system-on-chip (SOC), a single-board computer system (SBC) (such as, for example, a computer-on-module (COM) or system-on-module (SOM)), a desktop computer system, a laptop or notebook computer system, a mesh of computer systems, a mobile telephone, a personal digital assistant (PDA), a server, a tablet computer system, an augmented/virtual reality device, or a combination of two or more of these. Where appropriate, the computer system may reside in a cloud, which may include one or more cloud components in one or more networks.

In some embodiments, the computer system may include a processor Cpnt1, memory Cpnt2, storage Cpnt3, an input/output (I/O) interface Cpnt4, a communication interface Cpnt5, and a bus Cpnt6. The computer system may optionally also include a display Cpnt7, such as a computer monitor or screen.

Processor Cpnt1 includes hardware for executing instructions, such as those making up a computer program. For example, processor Cpnt1 may be a central processing unit (CPU) or a general-purpose computing on graphics processing unit (GPGPU). Processor Cpnt1 may retrieve (or fetch) the instructions from an internal register, an internal cache, memory Cpnt2, or storage Cpnt3, decode and execute the instructions, and write one or more results to an internal register, an internal cache, memory Cpnt2, or storage Cpnt3. In particular embodiments, processor Cpnt1 may include one or more internal caches for data, instructions, or addresses. Processor Cpnt1 may include one or more instruction caches, one or more data caches, such as to hold data tables. Instructions in the instruction caches may be copies of instructions in memory Cpnt2 or storage Cpnt3, and the instruction caches may speed up retrieval of those instructions by processor Cpnt1. Processor Cpnt1 may include any suitable number of internal registers, and may include one or more arithmetic logic units (ALUs). Processor Cpnt1 may be a multi-core processor; or include one or more processors Cpnt1. Although this disclosure describes and illustrates a particular processor, this disclosure contemplates any suitable processor.

Memory Cpnt2 may include main memory for storing instructions for processor Cpnt1 to execute or to hold interim data during processing. For example, the computer system may load instructions or data (e.g., data tables) from storage Cpnt3 or from another source (such as another computer system) to memory Cpnt2. Processor Cpnt1 may load the instructions and data from memory Cpnt2 to one or more internal register or internal cache. To execute the instructions, processor Cpnt1 may retrieve and decode the instructions from the internal register or internal cache. During or after execution of the instructions, processor Cpnt1 may write one or more results (which may be intermediate or final results) to the internal register, internal cache, memory Cpnt2 or storage Cpnt3. Bus Cpnt6 may include one or more memory buses (which may each include an address bus and a data bus) and may couple processor Cpnt1 to memory Cpnt2 and/or storage Cpnt3. Optionally, one or more memory management unit (MMU) facilitate data transfers between processor Cpnt1 and memory Cpnt2. Memory Cpnt2 (which may be fast, volatile memory) may include random access memory (RAM), such as dynamic RAM (DRAM) or static RAM (SRAM). Storage Cpnt3 may include long-term or mass storage for data or instructions. Storage Cpnt3 may be internal or external to the computer system, and include one or more of a disk drive (e.g., hard-disk drive, HDD, or solid-state drive, SSD), flash memory, ROM, EPROM, optical disc, magneto-optical disc, magnetic tape, Universal Serial Bus (USB)-accessible drive, or other type of non-volatile memory.

I/O interface Cpnt4 may be software, hardware, or a combination of both, and include one or more interfaces (e.g., serial or parallel communication ports) for communication with I/O devices, which may enable communication with a person (e.g., user). For example, I/O devices may include a keyboard, keypad, microphone, monitor, mouse, printer, scanner, speaker, still camera, stylus, tablet, touch screen, trackball, video camera, another suitable I/O device, or a combination of two or more of these.

Communication interface Cpnt5 may provide network interfaces for communication with other systems or networks. Communication interface Cpnt5 may include a Bluetooth interface or other type of packet-based communication. For example, communication interface Cpnt5 may include a network interface controller (NIC) and/or a wireless NIC or a wireless adapter for communicating with a wireless network. Communication interface Cpnt5 may provide communication with a WI-FI network, an ad hoc network, a personal area network (PAN), a wireless PAN (e.g., a Bluetooth WPAN), a local area network (LAN), a wide area network (WAN), a metropolitan area network (MAN), a cellular telephone network (such as, for example, a Global System for Mobile Communications (GSM) network), the Internet, or a combination of two or more of these.

Bus Cpnt6 may provide a communication link between the above-mentioned components of the computing system. For example, bus Cpnt6 may include an Accelerated Graphics Port (AGP) or other graphics bus, an Enhanced Industry Standard Architecture (EISA) bus, a front-side bus (FSB), a HyperTransport (HT) interconnect, an Industry Standard Architecture (ISA) bus, an InfiniBand bus, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or other suitable bus or a combination of two or more of these.

Although this disclosure describes and illustrates a particular computer system having a particular number of particular components in a particular arrangement, this disclosure contemplates any suitable computer system having any suitable number of any suitable components in any suitable arrangement.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

While the systems and methods have been described in conjunction with several specific embodiments, it is evident to those skilled in the art that many further alternatives, modifications, and variations will be apparent in light of the foregoing description. Thus, the systems and methods described are intended to embrace all such alternatives, modifications, applications and variations as may fall within the spirit and scope of the appended claims.

1. A method of determining a quality index for optical coherence tomography (OCT) data, comprising:
accessing, by one or more processors, the OCT data;
defining, by the one or more processors, a plurality of feature maps from the OCT data;
combining, by the one or more processors, groups of features maps into quality maps;
determining, by the one or more processors, feature vectors from average valued of n-patches of feature maps or quality maps, the feature vectors defining a subspace U;
determining, by the one or more processors, the square distances d from select feature vectors to the subspace U;
determining, by the one or more processors, a probability function of the square distances d being within a predefined range of variance; and
assigning, by the one or more processors, a quality index to the OCT data based on the probability function.
